(19) United States
(12) Patent Application Publication
(10) Pub. No.: US 2020/0202368 A1
(43) Pub. Date: Jun. 25, 2020

(54) PRODUCT ASSORTMENT OPTIMIZATION

(71) Applicant: Daniel Bruce PALMER, Atlanta, GA (US)

(72) Inventor: Daniel Bruce PALMER, Atlanta, GA (US)

(73) Assignee: The Coca-Cola Company, Atlanta, GA (US)

(21) Appl. No.: 16/642,611

(22) PCT Filed: Aug. 28, 2018
(86) PCT No.: PCT/US2018/048279

§ 371 Date: Feb. 27, 2020

Related U.S. Application Data
(60) Provisional application No. 62/550,859, filed on Aug. 28, 2017.

(51) Int. Cl. G06Q 30/02; G06Q 10/08; G06Q 10/06

(52) U.S. Cl. CPC G06Q 30/0202; G06Q 10/06375; G06Q 10/06393; G06Q 10/087

(57) ABSTRACT

An example method for preforming assortment optimization includes: selecting a product for introduction into a selected store; accessing historical sales data for a plurality of stores including the selected store; using the historical sales data to calculate a similarity of each of the stores to the selected store; selecting a subset of stores from the plurality of stores based upon similarity to the selected store; and calculating a projected sales velocity based upon sales from the historical sales data of the product at the subset of stores.

This application is being filed on Aug. 28, 2018, as a PCT International Patent application and claims the benefit of priority to U.S. Provisional patent application Ser. No. 62/550,859, filed Aug. 27, 2017, the entire disclosure of which is incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A large retailer can sell thousands of products at each of its stores. Even within a given retail category, there can be hundreds of different products for sale. With limited space at a given store, the ability to select those products with the highest potential for increased sales volume can be important. Such a task can be complex given the large number of products and stores.

### SUMMARY

In accordance with aspects of the present disclosure, an example method for preforming assortment optimization can include: selecting a product for introduction into a selected store; accessing historical sales data for a plurality of stores including the selected store; using the historical sales data to calculate a similarity of each of the stores to the selected store; selecting a subset of stores from the plurality of stores based upon similarity to the selected store; and calculating a projected sales velocity based upon sales from the historical sales data of the product at the subset of stores.

### DESCRIPTION OF THE DRAWINGS

FIG. 1 is a block diagram illustrating an example system for implementing assortment optimization.

FIG. 2 is a graphical user interface of a client computing device of FIG. 1 programmed to perform assortment optimization.

FIG. 3 is an example schema for historical sales data stored in a database of the system of FIG. 1.

FIG. 4 is an example input file including historical sales data for the system of FIG. 1.

FIG. 5 is an example output file of the system of FIG. 1.

FIG. 6 is an example table illustrating a calculation of similarity between stores of the system of FIG. 1.

FIG. 7 is an example table illustrating a calculation of projected average sales velocity for a selected product at a selected store of the system of FIG. 1.

FIG. 8 is an example graphical representation of a similarity of a plurality of stores of the system of FIG. 1.

FIG. 9 is another graphical representation of the similarity of the plurality of stores of FIG. 8 with stores selling the selected product being identified.

FIG. 10 is another graphical representation of the similarity of the plurality of stores of FIG. 9 with the closest five stores that sell the selected project being identified.

FIG. 11 is an example method for preforming assortment optimization using the system of FIG. 1.

FIG. 12 illustrates example physical components of the client computing device of the system of FIG. 1.

### DETAILED DESCRIPTION

In general, the following detailed description is directed to systems and methods that assist in determining an optimal mixture of products to be sold at a selected store, referred to herein as assortment optimization. This can be accomplished by providing sales projections for a plurality of possible store/product combinations, using historical retailer sales data as the basis.

In some examples provided herein, a decision may be made regarding whether or not to introduce a selected product into a selected store. To determine whether or not such an introduction is financially justified, historical sales data from a plurality of stores is examined, and stores having a certain similarity to the selected store are used to calculate a projected average sales velocity should the selected product be introduced into the selected store. This analysis assists in developing the proper assortment optimization for the selected store.

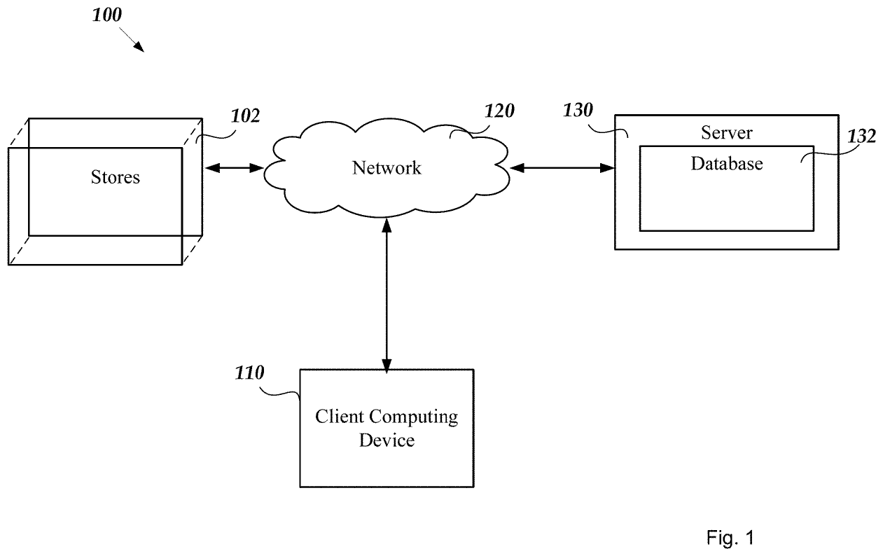

FIG. 1 is a block diagram illustrating an example system 100 including a plurality of stores 102. In some examples, these stores 102 can be managed by a retailing corporation having hundreds or thousands of stores spread across a geographic area. Examples of such retailing corporations include Wal-Mart Stores, Inc. of Bentonville, Ark., and Target Corporation of Minneapolis, Minn. Other types of stores are also applicable.

Each of the stores 102 sells hundreds or thousands of products within each of the stores 102. These products fall within different product categories, such as clothing, electronics, grocery, etc. Within each product category, there can be many more product lines.

The examples provided herein focus on a certain product category, beverages. However, the systems and methods described herein can be applied to almost any product category and/or product line.

It should be understood that the term “beverage,” as used herein, includes, but is not limited to, pulp and pulp-free citrus and non-citrus fruit juices, fruit drink, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combinations thereof. The beverage may also be carbonated or non-carbonated. The beverage may comprise beverage components (e.g., beverage bases, colorants, flavorants, and additives).

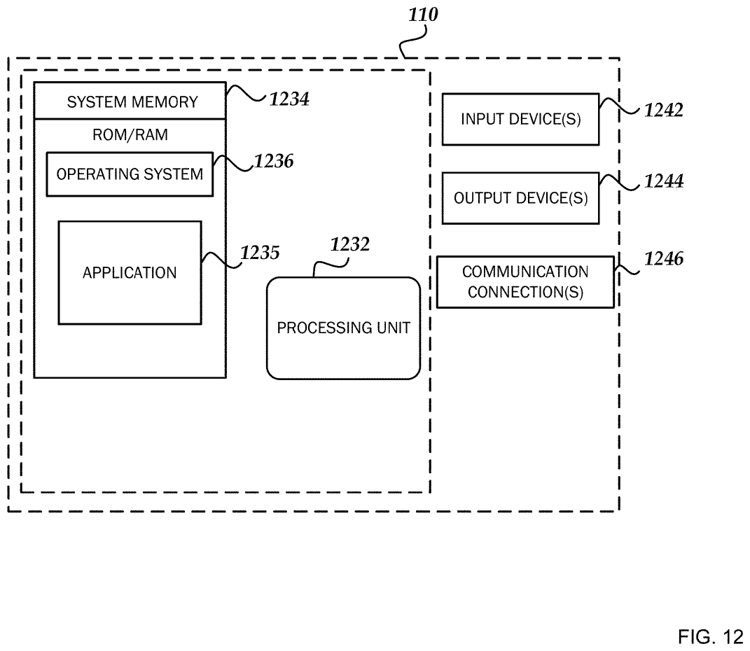

Also provided within the system 100 is a client computing device 110, which is typically one or more computing devices. The physical components of the client computing device 110 are described below with reference to FIG. 12. The client computing device 110 communicates with a server 130 and a database 132 through a network 120.

As described further below, the client computing device 110 is programmed to assist in the selection of the products sold at one or more of the stores 102. In these examples, the client computing device 110 leverages data and processing power of the server 130 and database 132 to project a volume of sales for a selected product, such a particular beverage, at one of the stores 102. This can be referred to as assortment optimization.

In this example, the server 130 is also one or more computing devices. The server 130 can include significant computing resources, such as mainframe resources, to complete computation-intensive projects, such as those required for assortment optimization.

The database 132 can be used to store large amounts of data, such as historical sales data for the retailer. As described further below, this historical sales data can be used as part of the assortment optimization process.

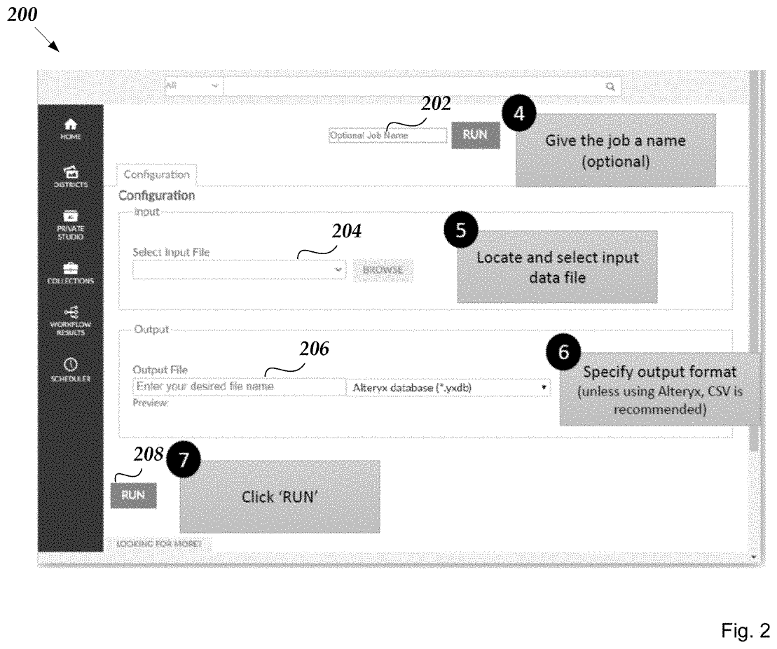

Referring now to FIG. 2, an example graphical user interface 200 as displayed by the client computing device 110 is shown. The example interface 200 includes a plurality of input fields that can be used to initiate the assortment optimization process.

An example input field 202 of the interface 200 allows the user to name the particular project. This can be advantageous to keep track of different assortment optimization projects using different names. This can be important, given that a project can take hours or days to complete depending on the number of products and/or stores involved in assortment optimization.

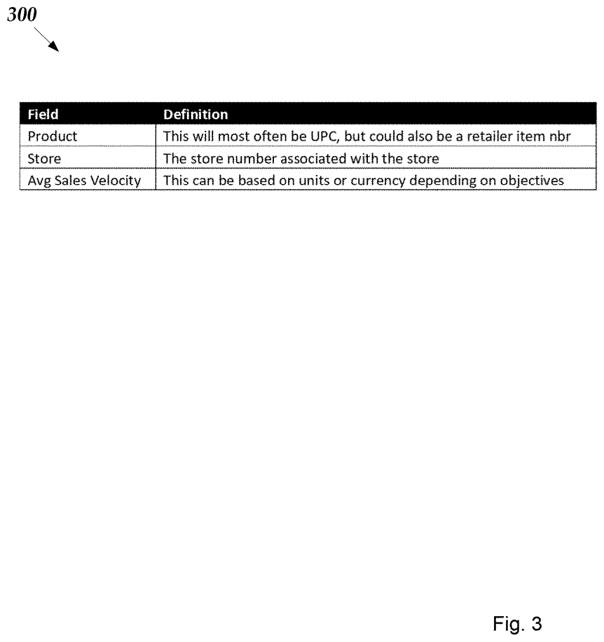

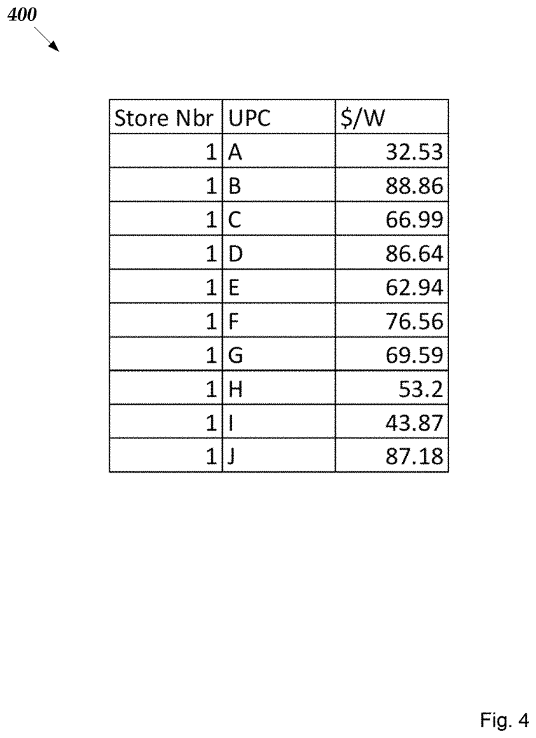

The interface 200 also includes an input field 204 to allow the user to identify input data. This input data includes historical sales data that is used by the system 100 to perform assortment optimization. In some examples, the input data is extracted from the database 132 of the server computer 130. See FIGS. 3-4 and accompanying description for additional details regarding the input file.

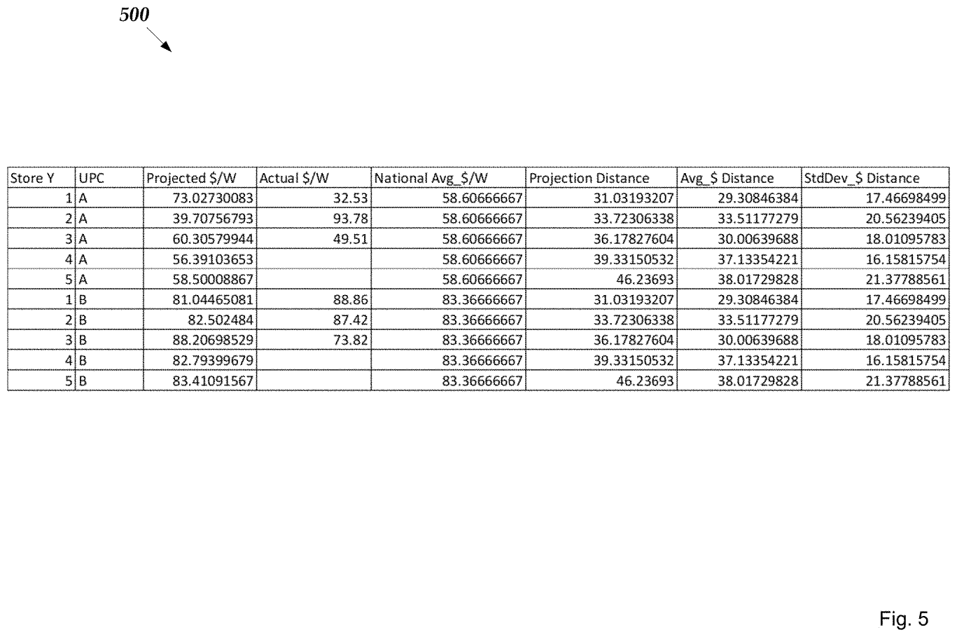

An input field 206 allows the user to define the name, location, and file type of the output data of the system 100. In this example, the output data is generated in a database format, such as the database format defined by Alteryx of Irvine, Calif., for storage in the database 132. See FIG. 5 and accompanying description for additional details regarding the output data.

Finally, a control 208 is selectable by the user to run the assortment optimization process, as described further below.

Referring now to FIGS. 3-4, additional details are provided on the input data for the system 100.

FIG. 3 depicts an example schema 300 for the input data. The input data can include a product field, a store field, and an average sales velocity field.

The product field is a unique identifier for a particular product. The unique identifier can be a Universal Product Code (UPC) associated with the product. The unique identifier could also be a different code, such as a unique code assigned by a retailer for each product.

The store field uniquely identifies one of the plurality of stores for the retailer. In this example, the store field can be a store number, although any other identifier can also be used.

The average sales velocity field identifies the rate of sales for a particular product for a given period of time. In the examples provided herein, the average sales velocity is measured in dollars per week. However, many other metrics could be used, such as units sold, over different time spans, such as week, month, or year.

FIG. 4 depicts an excerpt of example input data 400 for the system 100. In this excerpt, data for store number 1 is shown. For products with UPC numbers A-J, the sales velocity (in dollars per week) is provided. A complete input file would include thousands or millions of entries given the number of stores 102 and products sold at those stores.

In the examples provided herein, the system 100 uses one or more algorithms to estimate the sales velocity for a selected product at a selected store. This estimate can be provided in various ways. In these examples, the sales velocity is estimated using the k-nearest neighbors algorithm, which is a mathematical approach that determines a “similarity” between two stores. This similarity is representative of mathematical distance, as dictated by the historical sales data. Other similar techniques can also be used.

Specifically, the system 100 uses the historical data from the input data 400 to estimate a sales velocity for a selected product at a selected store that does not currently sell that selected product.

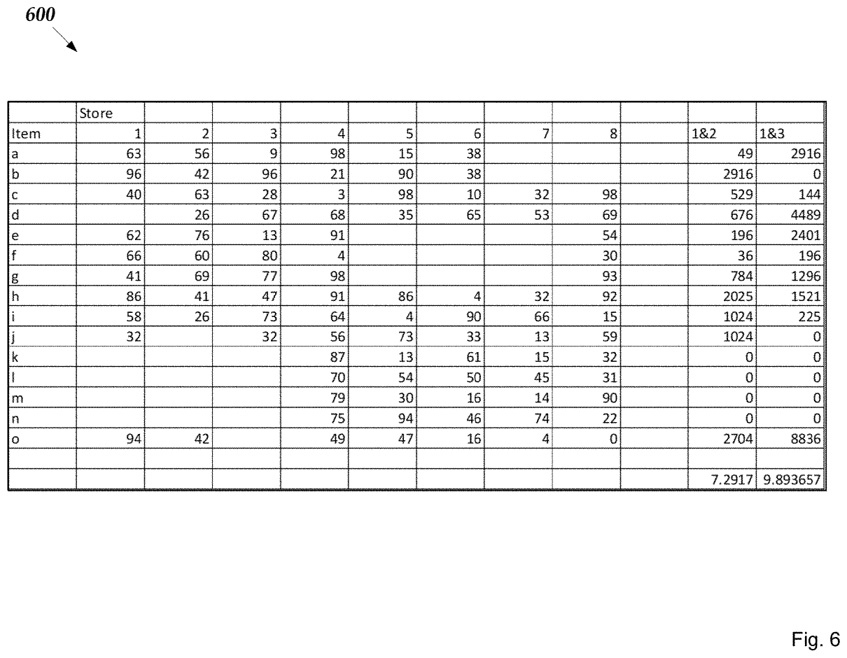

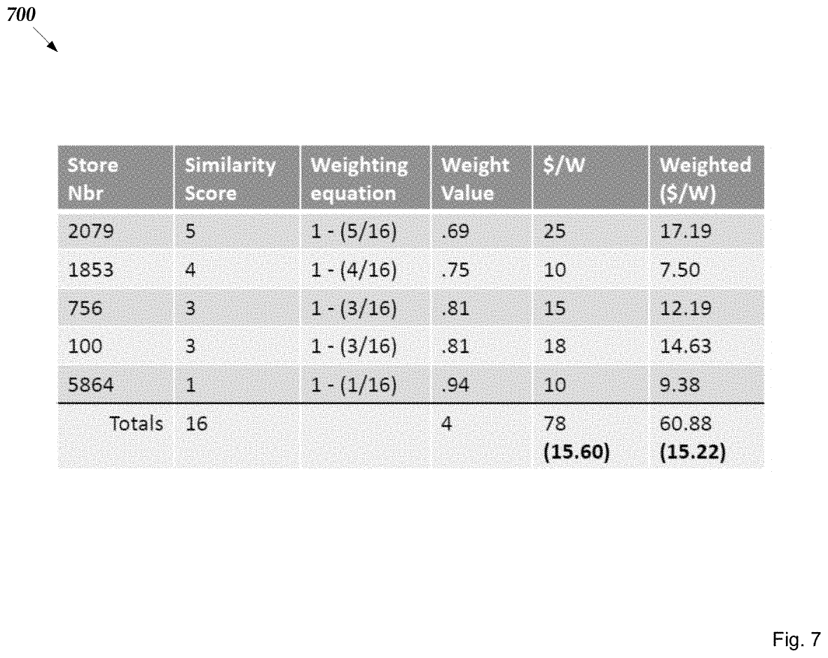

FIG. 5 shows an excerpt of an example output file 500. This output file 500 includes each store number 1-5 and products A and B. The projected average sales velocity (Projected $/W) is provided per the calculations described below with reference to FIGS. 6-7 and accompanying description. Also, the actual and national average sales figures are provided, where applicable. For example, store numbers 4 and 5 did not sell product A according to the input data, so the actual average sales velocity is zero.

FIG. 6 depicts an example table 600 illustrating an excerpt of an application of the k-nearest neighbors algorithm, which is used to calculate the relative similarity of each of the stores 102. The table 600 includes the historical sales data (i.e., average sales velocity expressed in dollars per week) for product numbers a-o at store numbers 1-8. This information is from the input data.

In addition, the table 600 includes a comparison of store numbers 1 and 2 and store numbers 1 and 3 for each of the product numbers a-o. This comparison is referred to herein as the “similarity score”. This is accomplished, for example, using the following equation A.

(average sales velocity_{product a @ store 1}−average sales velocity_{product a @ store 2})² (A)

For example, for product a at stores 1 and 2, this result is (63−56)²=49. The result of each store comparison (similarity score) shown at the end of the file 600 is calculated using the following equation B.

$$\frac{\sqrt{{\sum }_{product a}^{product o} comparison of store 1 and store 2}}{total number of products} \qquad ( B )$$

In this example, the total result of the comparison of stores 1 and 2 is calculated as follows:

$$\frac{\sqrt{\begin{matrix}49 + 2916 + 529 + 676 + 196 + 36 + 784 + \\ 2025 + 1024 + 1024 + 0 + 0 + 0 + 0 + 2704\end{matrix}}}{15} = 7.2917 .$$

This similarity score represents the relative similarity of store numbers 1 and 2. The lower the similarity score, the closer the match between the stores, as described further below.

Although columns for only the comparison of stores 1 and 2 and stores 1 and 3 are shown in table 600, this comparison is done for every product between every store.

As shown in FIG. 7, after these comparisons are completed, the similarity scores are used to select specific stores to calculate the projected average sales velocity for the desired product at the selected store. In this example, the five stores with the closest similarity store are examined to make this projection. However, more or fewer stores can be used. For example, 10 or 20 stores could be used.

The table 700 in FIG. 7 shows the five stores with the closest similarity score to the selected store. For each of these stores, a weighting equation is used based upon the total similarity score for each of the selected stores (5+4+3+3+1=15), and a weight value is calculated for each of the selected stores (e.g., 1−(5/16)=0.69 for store number 2079). A store with a better similarity score (i.e., closer) has a higher weight value, as shown by the different weight values for store numbers 2079 and 5864.

A weighted average sales velocity is calculated by taking the actual average sales velocity and multiplying that by the weight value for each of the selected stores. The projected average sales velocity and projected weighted sales velocity are then calculated using the totals of each column divided by the total weight value.

In this example, for the selected product in the selected store, the projected weighted salves velocity is 15.22. This means that there will be projected sales of $15.22 per week if the selected product is introduced into the selected store.

In the example shown, the historical data includes all of the products sold by all of the stores for the retailer. In other examples, the data can be culled or otherwise modified for various reasons to modify the results.

For example, in another embodiment, the historical data can be limited to historical data for sales in a given product category, such as beverages. In yet another example, the historical data can be limited to sales of specific products, such as a specific product line or lines.

In other examples, certain data can be flagged or otherwise excluded from the historical data for various reasons. For example, data from stores not carrying the selected product can be excluded. In another example, stores in certain geographic markets or exhibiting certain dissimilarities with the selected store can be excluded. Other examples are possible.

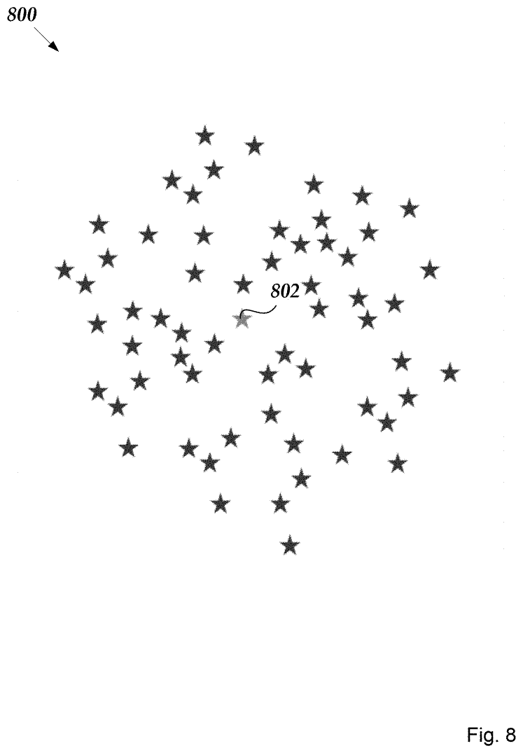

FIGS. 8-10 provide a visual representation of the “similarity” of a given set of stores.

In the example graphical representation 800 of FIG. 8, each store is represented by a star. The relative similarity of each star indicates its mathematical closeness (i.e., similarity) to the stores surrounding it based upon the similarity scores calculated by the system 100. The store 802 is the selected store for which the selected product may be introduced.

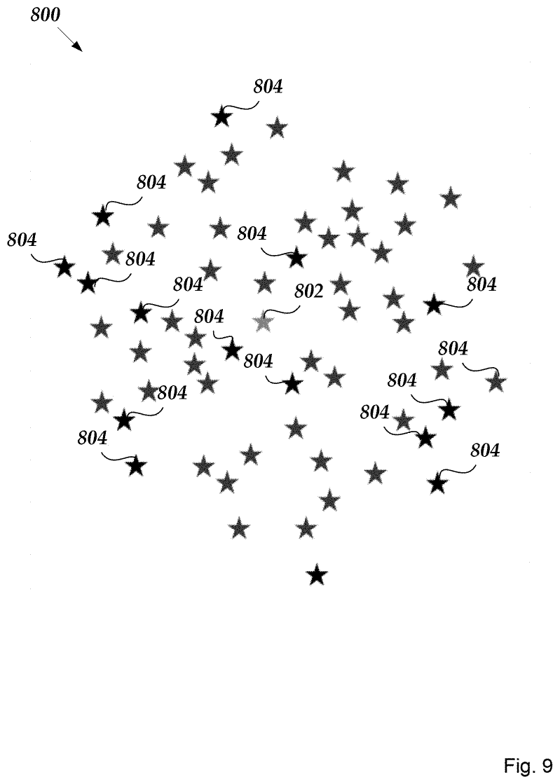

As shown in FIG. 9, stores 804 have historically sold the selected product and therefore have average sale velocity data that can be used (i.e., in the input file). These stores are therefore compared for similarity (i.e., using the similarity score described above) to the selected store 802.

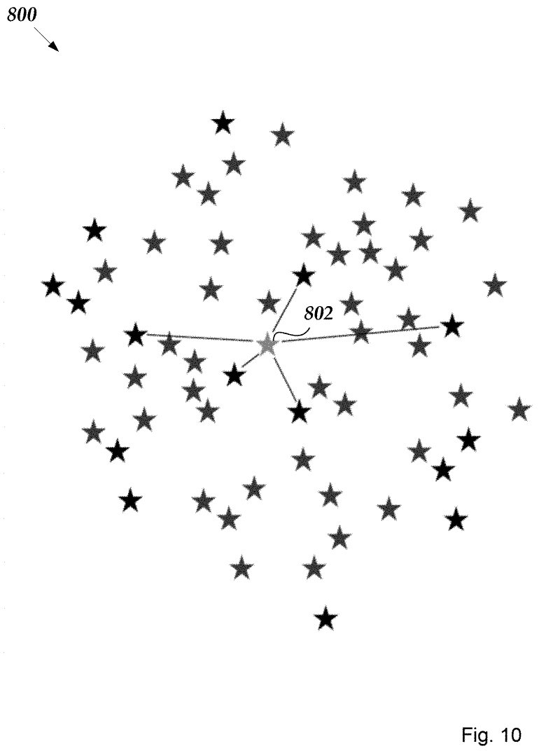

FIG. 10 illustrated the five closest stores to the selected store 802. The sales data from these five stores is be used, as described above, to calculate the projected average sales velocity.

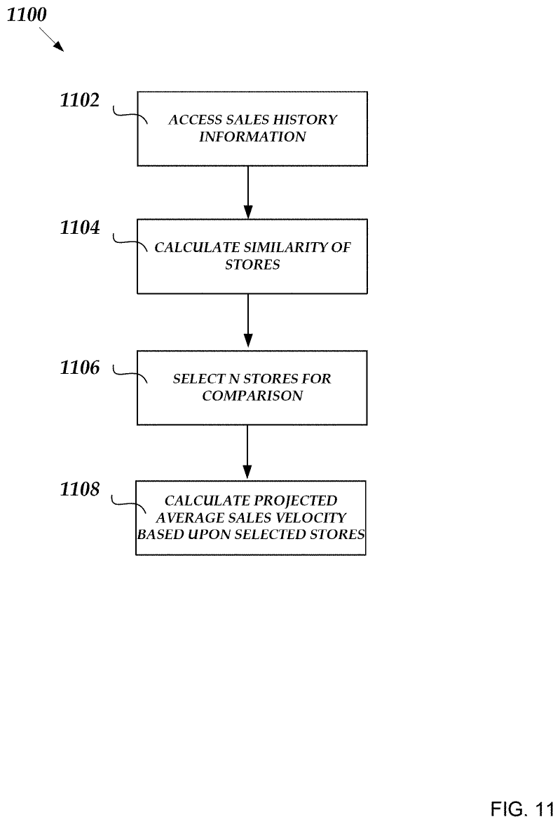

FIG. 11 is an example method 1100 for calculating the projected average sales velocity for a selected product for assortment optimization as described herein.

At operation 1102, historical sales data is accessed. This can be accomplished, for example, by querying the database 132 to obtain historical sales data stored therein.

Next, at operation 1104, a calculation of similarity is performed for the stores represented within the historical sales data. As noted, this can be accomplished using, for example, the k-nearest neighbors algorithm.

At operation 1106, a certain number of stores is selected for comparison to the selected store, such as the five most similar stores having sold the selected product. Finally, at operation 1108, the projected average sales velocity is calculated based upon the sales of the selected product at the selected stores.

Various technological advantages are associated with the systems and methods described herein. An example of such a technological advantage is the systems and methods allow the computing devices of the present system to more efficiently calculate a proper assortment of products for sale at each store. Further, this optimization assists in the management of inventory at the stores, thereby increasing and/or decreasing supplies of products as needed based upon projected sales velocities. This results in a more efficient supply-chain system. Other or different advantages are possible.

FIG. 12 is a simplified block diagram illustrating further aspects of the client computing device 110 of FIG. 1. The server 130 can be configured in a similar manner.

In a basic configuration, the client computing device 110 includes at least one processing unit 1232 and a system memory 1234. Depending on the configuration and type of computing device, system memory 1234 may comprise, but is not limited to, volatile (e.g. random access memory (RAM)), non-volatile (e.g. read-only memory (ROM)), flash memory, or any combination. The system memory 1234 may include an operating system 1236 and software code for implementing various applications 1235. The operating system 1236 may be suitable for controlling operation of the client computing device 110.

The client computing device 110 may also include additional data storage devices (not shown) which may be removable and/or non-removable such as, for example, magnetic disks, optical disks, solid state storage devices (“SSD”), flash memory or tape. The client computing device 110 may also have input device(s) 1242 such as a keyboard, a mouse, a pen, a sound input device (e.g., a microphone), a touch input device, etc. Output device(s) 1244 such as a touchscreen display, speakers, a printer, etc. may also be included. The aforementioned devices are examples and others may be used. Communication connection(s) 1246 may also be included and utilized to connect to the Internet 120 (or other types of networks) as well as to remote computing systems such as the server computer 130.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information (such as computer readable instructions, data structures, program modules, or other data) in hardware. The system memory 1234 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the client computing device 110. Any such computer storage media may also be part of the client computing device 110. Computer storage media does not include a carrier wave or other propagated or modulated data signal.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Various embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for preforming assortment optimization, the method comprising:
selecting a product for introduction into a selected store;
accessing historical sales data for a plurality of stores including the selected store;
using the historical sales data to calculate a similarity of each of the stores to the selected store;
selecting a subset of stores from the plurality of stores based upon similarity to the selected store; and
calculating a projected sales velocity based upon sales from the historical sales data of the product at the subset of stores.

2. The method of claim 1, further comprising selecting a Universal Product Code of the product.

3. The method of claim 1, further comprising calculating a sale volume per week for the selected product at each of the plurality of stores.

4. The method of claim 1, further comprising calculating a mathematical distance between the selected store and each of the subset of stores.

5. The method of claim 1, further comprising calculating a similarity score between each of the subset of stores.

6. The method of claim 5, further comprising calculating the similarity score by comparing a first average sales velocity of the product at a first store of the plurality of stores with a second average sales velocity of the product at a second store of the subset of stores.

7. The method of claim 6, wherein a lower similarity score indicates a closer match between the first store and the second store.

8. The method of claim 1, further comprising calculating a weighted average sales velocity for each of the subset of stores to calculate the projected sales velocity.

9. The method of claim 1, further comprising limiting the historical sales data to a product category.

10. The method of claim 9, further comprising limiting the historical sales data to a beverages product category.

11. A system for assortment optimization, the system comprising:
at least one processor; and
memory encoding instructions which, when executed by the at least one processor, cause the at least one processor to:
select a product for introduction into a selected store;
access historical sales data for a plurality of stores including the selected store;
use the historical sales data to calculate a similarity of each of the stores to the selected store;
select a subset of stores from the plurality of stores based upon similarity to the selected store; and
calculate a projected sales velocity based upon sales from the historical sales data of the product at the subset of stores.

12. The system of claim 11, further comprising instructions which, when executed by the at least one processor, cause the at least one process to select a Universal Product Code of the product.

13. The system of claim 11, further comprising instructions which, when executed by the at least one processor, cause the at least one process to calculate a sale volume per week for the selected product at each of the plurality of stores.

14. The system of claim 11, further comprising instructions which, when executed by the at least one processor, cause the at least one process to calculate a mathematical distance between the selected store and each of the subset of stores.

15. The system of claim 11, further comprising instructions which, when executed by the at least one processor, cause the at least one process to calculate a similarity score between each of the subset of stores.

16. The system of claim 15, further comprising instructions which, when executed by the at least one processor, cause the at least one process to calculate the similarity score by comparing a first average sales velocity of the product at a first store of the plurality of stores with a second average sales velocity of the product at a second store of the subset of stores.

17. The system of claim 16, wherein a lower similarity score indicates a closer match between the first store and the second store.

18. The system of claim 11, further comprising instructions which, when executed by the at least one processor, cause the at least one process to calculate a weighted average sales velocity for each of the subset of stores to calculate the projected sales velocity.

19. The system of claim 11, further comprising instructions which, when executed by the at least one processor, cause the at least one process to limit the historical sales data to a product category.

20. The system of claim 19, further comprising instructions which, when executed by the at least one processor, cause the at least one process to limit the historical sales data to a beverages product category.
